(19) United States
(12) Patent Application Publication
(10) Pub. No.: US 2024/0118691 A1
(43) Pub. Date: Apr. 11, 2024

(54) AUGMENTED REALITY EXPERIENCE FOR PASSENGER CONTROL OF AUTONOMOUS VEHICLE

(71) Applicant: GM GLOBAL TECHNOLOGY OPERATIONS LLC, Detroit, MI (US)

(72) Inventors: Frank C. Valeri, Novi, MI (US); Timothy J. Roggenkamp, Brighton, MI (US)

(73) Assignee: GM GLOBAL TECHNOLOGY OPERATIONS LLC, Detroit, MI (US)

(21) Appl. No.: 17/961,167

(22) Filed: Oct. 6, 2022

(51) Int. Cl. G05D 1/00; G06F 3/01

(52) U.S. Cl. CPC G05D 1/0044; G05D 1/0016; G05D 1/0038; G06F 3/011; G06F 3/016; G06F 3/017; G05D 2201/0212; G05D 2201/0213

(57) ABSTRACT

An augmented reality system operable to provide passengers with a personalized augmented reality environment and experience. The augmented reality system may select the augmented reality environment according to a plurality of augmented reality themes, with the passengers being enabled to personalize their traveling experience and/or to interact with virtual objects to generate virtual commands suitable for use in implementing real control of the autonomous vehicle.

### INTRODUCTION

The present disclosure relates to facilitating real control of autonomous vehicles in response to passenger interactions with virtual objects, such as but not necessarily limited to an augmented reality system operable to provide passengers with a personalized augmented reality environment and experience through which the passengers may interact with virtual objects to generate virtual commands suitable for use in implementing real control of the autonomous vehicle.

An autonomous vehicle may correspond with a class of vehicle configured to autonomously operate without requiring direct involvement from its passengers, which in some cases may result in the autonomous vehicle performing operations, driving passengers to destinations, and otherwise undertake activities according to a pre-programmed set or schedule of commands and strategies, optionally with automated assistance from telemetry, guidance, and other onboard vehicle systems. An autonomous vehicle, for example, may be capable of transporting passengers from one location to another without requiring the passengers to undertake activities associated with controlling, navigating, securing, or otherwise managing operation of the autonomous vehicle, with some autonomous vehicles being considered as “driverless” in the sense of lacking a steering wheel or other physical interfaces for a driver or other operator to intervene or otherwise supersede the automated control. Passengers within such autonomous vehicles, particularly when left with no physical or real-world controls for directing the vehicle, may essentially be left with an impersonal environment and with little if any interaction with operation of the vehicle beyond looking out the window until the destination is reached.

### SUMMARY

One non-limiting aspect of the present disclosure relates to an augmented reality controller operable for providing a virtual environment for passengers within an autonomous vehicle. The augmented reality system may select the virtual environment according to a plurality of themes made available to the passenger, with the passengers being enabled to personalize their traveling experience, and in some situations, to interact with virtual objects to generate virtual commands suitable for use in implementing real control of the autonomous vehicle. The passengers may thereby virtually interact with the virtual objects to select and participate in a personalized travel environment, to generate virtual commands for use in implementing real control of the autonomous vehicle, and/or to perform other operations the passengers would otherwise be unable to implement in the real-world environment of the autonomous vehicle.

One non-limiting aspect of the present disclosure relates to an augmented reality system for passenger control of an autonomous vehicle. The system may include an augmented reality controller operable to provide an augmented reality experience for a plurality of passengers while traveling within the autonomous vehicle. The augmented reality experience may include associating one or more of an available plurality of augmented reality themes with each of the passengers, selecting virtual objects for each of the passengers based on the augmented reality theme associated therewith, providing object overlays to visual devices associated with each of the passengers with the object overlays visually displaying virtual objects within a real environment of the passenger associated therewith, and recognizing virtual interactions of the passengers with the virtual objects based on signaling transmitted from a gesture device of the passenger associated therewith. The system may further include an autonomous vehicle controller operable to control a real operation of the autonomous vehicle according to a virtual command generated by the augmented reality controller in response to the virtual interactions.

The autonomous vehicle may be autonomously controlled to transport the passengers to a destination, with the virtual objects representing points of interest along a route to the destination and the real operation being a stop operation or a slowdown operation associated with stopping or slowing the autonomous vehicle at one or more of the points of interest.

The augmented reality controller may select different points of interest for the passengers depending on the augmented reality theme associated therewith.

The augmented reality controller may select one of the virtual objects to be a window control actuator and the real operation to be an actuate window operation associated with raising or lowering a real window included as part of the autonomous vehicle.

The augmented reality controller may be configured to select a bus theme for each of the passengers, with the virtual objects associated therewith including object overlays for displaying a virtual bus cord to each of the passengers, and to generate the virtual command as a virtual stop command when the virtual interactions of one of the passengers indicates the associated passenger to have actuated the virtual bus cord. The autonomous vehicle controller may be operable to stop the vehicle in response to the virtual stop command.

The autonomous vehicle may be a driverless type of vehicle lacking a real actuator for the passengers to request the real operation independently of the augmented reality experience

One non-limiting aspect of the present disclosure relates to method for augmented reality passenger control of an autonomous vehicle. The method may include providing object overlays to a visual device worn on a passenger with the object overlays visually depicting virtual objects within a real environment of the passenger, detecting virtual interactions of the passenger with the virtual objects, and controlling a real operation of the autonomous vehicle within the real environment based on the virtual interactions.

The method may include the real operation being a stop operation associated with autonomously navigating to and stopping the vehicle at a location of interest selected by the passenger with one of the virtual interactions, the virtual interactions being detected according to signaling communicated from a gesture device, and the gesture device being worn on or carried by the passenger separately from the visual device to register a non-verbal physical gesture made by the passenger.

The method may include selecting one or more the virtual objects to represent points of interest along a route to a destination of the autonomous vehicle and controlling the real operation to include stopping or slowing the autonomous vehicle at one or more of the points of interest in response to one or more of the virtual interactions.

The method may include selecting one or more of the virtual objects to represent selectable controls for one or more real systems onboard the autonomous vehicle, optionally with the real operation including controlling one or more of the real systems in response to one or more of the virtual interactions.

The method may include selecting one or more of the virtual objects to represent selectable controls for a window control actuator, optionally with the real operation including raising or lowering a real window included as part of the autonomous vehicle in response to one or more of the virtual interactions therewith.

One non-limiting aspect of the present disclosure relates to augmented reality system for passenger control of an autonomous vehicle. The system may include a device controller operable to detect and communicate with a visual device worn on or carried by a passenger within the autonomous vehicle, an augmented reality controller operable with the device controller to provide an augmented reality experience for the passenger while traveling within the autonomous vehicle with the augmented reality experience including displaying virtual objects to the passenger via the visual device, and an autonomous vehicle controller operable to control a real operation of the autonomous vehicle according to a virtual command generated by the augmented reality controller in response to virtual interactions of the passenger with the virtual objects.

The augmented reality experience may include determining an augmented reality theme for the passenger, selecting virtual objects for the passenger based on the augmented reality theme, providing object overlays to the visual device via the device controller with the object overlays visually depicting the virtual objects within a real environment of the passenger, and detecting the virtual interactions according to signaling transmitted to the device controller from a gesture device worn on or carried by the passenger.

The augmented reality controller may be configured to determine the augmented reality theme to be a selected one of a plurality of augmented reality themes made available to the passenger through a subscription and identify the selected one of the plurality of augmented reality themes according to a corresponding one or more of the virtual interactions.

The augmented reality controller may be operable to vibrate or engage a tactile element of the gesture device according to a real speed of the autonomous vehicle such that a vibration induced thereby increases and decreases in proportion to the real speed increasing and decreasing.

The autonomous vehicle may lack a brake pedal or other real actuator for the passengers to request the real operation independently of the augmented reality experience.

The real operation may be a navigation operation associated with autonomously navigating to another destination or temporarily to another route other than a predefined destination or a predefine route pre-programmed for the autonomous vehicle.

The augmented reality controller may be operable to animate one or more of the virtual objects according to a real speed of the autonomous vehicle such that an animation speed of the animated one or more is increases and decreases as the real speed increases and decreases.

The augmented reality controller may be operable to select and update points of interest displayed as one or more of the virtual objects as a function of changes in a location of the autonomous vehicle registered while the autonomous vehicle travels to a pre-programmed destination.

The autonomous vehicle controller may generate and transmit a real command over a vehicle network to command a real vehicle system to implement the real operation.

These features and advantages, along with other features and advantages of the present teachings, are readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates an augmented reality system for an autonomous vehicle in accordance with one non-limiting aspect of the present disclosure.

FIG. 2 illustrates a schematic view of an augmented reality scene in accordance with one non-limiting aspect of the present disclosure.

FIG. 3 illustrates a flowchart of a method for providing an augmented reality experience in accordance with one non-limiting aspect of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

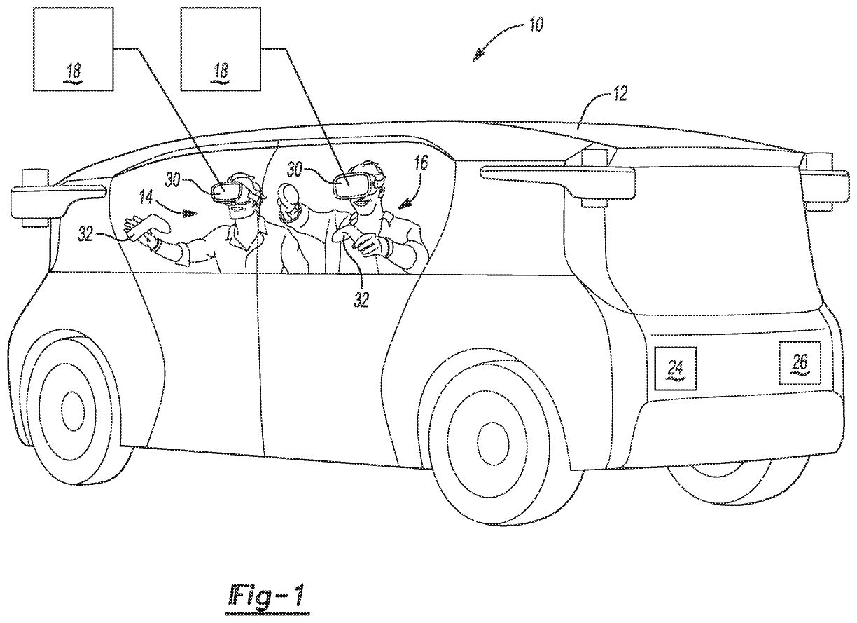

FIG. 1 illustrates an augmented reality system 10 for an autonomous vehicle 12 in accordance with one non-limiting aspect of the present disclosure. The autonomous vehicle 12 is shown for exemplary purposes to correspond with a passenger type of vehicle 12 configured to autonomously transport multiple passengers 14, 16 from one location to another, such as according to a pre-programmed set or schedule of commands and strategies, optionally with automated assistance from telemetry, radar, guidance, navigation, and other onboard vehicle 12 system 10. The autonomous vehicle 12, for example, may be capable of transporting the passengers 14, 16 from one location to another without requiring the passengers 14, 16 to undertake activities associated with controlling, navigating, securing, or otherwise managing operation of the autonomous vehicle 12, optionally with the autonomous vehicle 12 being considered as “driverless” in the sense of lacking a steering wheel or other physical interfaces for a driver or other operator to intervene or otherwise supersede the automated control through real-world, passenger directed interactions with physical, tactile, or hands-on features included within the autonomous vehicle 12. To this end, an autonomous vehicle 12 controller may be included to control the autonomous activities of the autonomous vehicle 12.

The autonomous vehicle 12, for example, may correspond with a mass transit type of vehicle 12, like a bus, plane, train, shuttle, etc., configured to autonomously transport a plurality of passengers 14, 16 to a destination, such as a mass transit vehicle 12 utilized to transport passengers from a subway stop to one or more destinations, pick-up and drop-off passengers 14, 16 at one or more of a plurality of stops included on a bus route, ferry travelers from one airport terminal to another, etc. The autonomous vehicle 12 may also be a non-mass transit type of vehicle 12, such as a personal automobile, bicycle, scooter, tractor, etc., tasked with transporting fewer passengers 14, 16, or a single passenger. The present disclosure is predominately described with respect to the autonomous vehicle 12 being configured to autonomously transport more than one passenger in order to demonstrate advantageous capabilities of the present disclosure to individually personalize the manner in which each passenger may be transported, optionally without influencing the personalization of the other passengers 14, 16. This is done, however, for non-limiting purposes as one skilled in the art will appreciate the multiple passenger personalization may be similarly applicable to a single passenger.

One non-limiting aspect of the present disclosure contemplates augmented reality system 10 being operable for providing a virtual environment for passengers 14, 16 with an autonomous vehicle 12. The augmented reality system 10 may select the virtual environment according to a plurality of themes made available to the passengers 14, 16, with the passengers 14, 16 being enabled to personalize their traveling experience, and in some situations, to interact with virtual objects 18 to generate virtual commands suitable for use in implementing real control of the autonomous vehicle 12. The passengers 14, 16 may thereby virtually interact with the virtual objects 18 to select and participate in a personalized travel environment, to generate virtual commands for use in implementing real control of the autonomous vehicle 12, and/or to perform other operations the passengers 14, 16 would otherwise be unable to implement in the real-world environment of the autonomous vehicle 12. The present disclosure, at least in this manner, may be operable to provide an augmented reality experience for the passengers 14, 16 that not only enables the passengers 14, 16 to customize the traveling experience but also to explore points of interest and engage in other activities while being autonomously driven, which may be beneficial in improving satisfaction with autonomous transport while also providing passengers 14, 16 with engagement beyond simply looking out a window until the destination is reached.

The augmented reality system 10 may include a device controller 24 and an augmented reality controller 26 onboard the autonomous vehicle 12, or otherwise in communication therewith, to provide the augmented reality experience contemplated herein. The device controller 24 and the augmented reality controller 26 may be differentiated for exemplary purposes as the operation and/or the functions associated therewith may be performed by the same device, which may optionally be offboard the vehicle 12. The device controller 24 and the augmented reality controller 26 may be constructed as devices, processes, etc. configured in accordance with the present disclosure to facilitate signaling, generating graphics, and otherwise enabling the augmented reality experience contemplated herein, such as according to corresponding execution a plurality of non-transitory instructions stored on a computer readable storage medium associated therewith. The device and augmented reality controllers 24, 26 may be described separately in order to differentiate the operations of the present disclosure with respect to the augmented reality environment (i.e., those activities associated with the augmented reality controller 26) and the communications and other signaling associated with supporting the augmented reality environment (i.e., those associated with the device controller 24).

While other methodologies and devices may be employed to facilitate interfacing passengers 14, 16 with the augmented reality environment, one non-aspect of the present disclosure contemplates facilitating passenger interaction between the real world and the virtual world with the use of one or more wearables 30, 32 worn or carried by the passengers 14, 16. One type of wearable may be visual device 30 configured to interface computer generated or electronic graphics, images, indicia, etc. with the passengers 14, 16 and another type of wearable may be a gesture device 32 configured to register verbal and/or non-verbal physical gestures made in the world by the passengers 14, 16. The visual device 30 may include a display configured to optically interface images with the wearer, optionally with an associated visual display being hidden or otherwise unviewable by the other passengers 14, 16, i.e., each passenger may have their own separate and dedicated display. The visual device 30 may be configured to present for virtual objects 18 as object overlays where the object overlays provide a visual representation of the virtual objects 18 relative to a real environment of passenger.

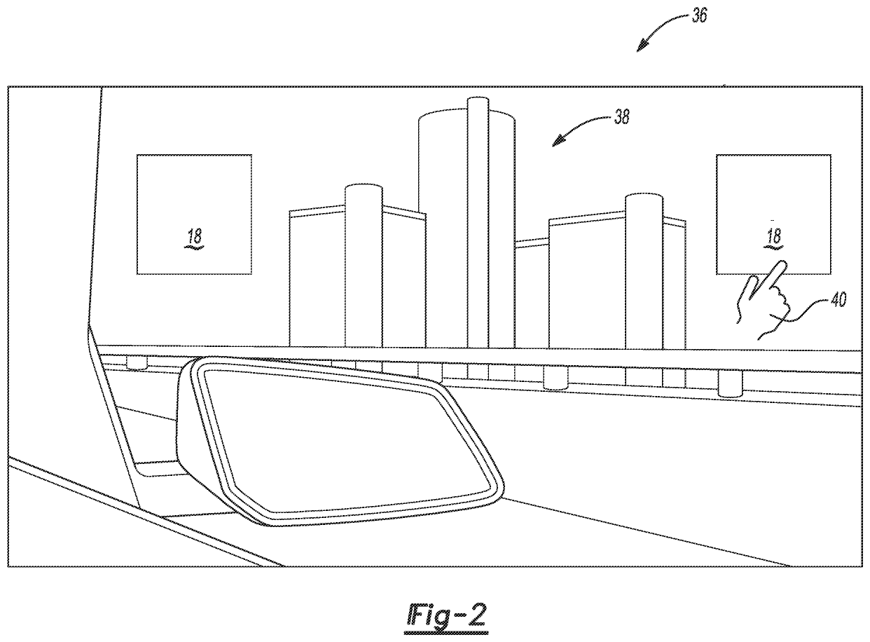

FIG. 2 illustrates a schematic view of an augmented reality scene 36 in accordance with one non-limiting aspect of the present disclosure. The augmented reality scene may correspond with the augmented reality experience provides to the passenger 14 via one of the visual devices 30, which may include a combination of virtual objects 18 and real objects 38. The virtual objects 18 may be corresponding computer generated images prepared by the augmented reality controller 24 for interfacing with the passenger 14 through the visual device 30, which may be generically referred to herein as virtual objects 18. The visual representation of the virtual objects 18, or portions thereof, may correspond with object overlays or other computer constructs sufficient for visual presentation through the visual devices 30. The real objects 38 may correspond with features in the real world surrounding the autonomous vehicle 12 that the passengers 14 may be able to engage physically or tactilely, which are shown for exemplary purposes to correspond with a landscape and other futures viewable through a window of the autonomous vehicle 12. The virtual object overlays used to represent the virtual objects 18, as such, may be considered as the augmented reality environment provided to the passenger 14 relative to the real world 38 viewable through the window.

The gesture device 32 worn by each passenger 14, 16, which is shown for exemplary purposes to be separate from the visual device 30 and worn on a wrist of the passengers 14, 16, may be configured to enable passenger interaction with the virtual objects 18. The corresponding virtual interactions may be generated as a result of the passenger 14 using the gesture device 32 to facilitate activation, selection, manipulation, or other exploitation of the virtual objects 18. The virtual interactions may be facilitated in the illustrated manner with a pointer icon 40, which is shown as a virtual representation of a hand actively moving and grabbing the virtual object 18, which may alternatively, such that the passenger 14 may use the pointer icon 40 to interact with the virtual objects 18 to generate the corresponding virtual interactions while simultaneously viewing the real objects 38 in a background thereof. The virtual interactions between the passenger and the virtual objects 18 may be used in the manner contemplated herein to personalize the travel environment, to generate virtual commands for use in implementing real control of the autonomous vehicle 12, and/or to perform other operations the passengers 14, 16 would otherwise be unable to implement in the real-world environment of the autonomous vehicle 12.

The augmented reality system 10 may be used in this manner to connect wearables 30, 32 and to establish a wireless connection (Bluetooth, Wifi, . . . ) with the autonomous vehicle 12. Once connected, the augmented reality system 10 may be configured to allow the passengers 14, 16 to control real or actual vehicle 12 operation and decisions along with providing a fully interactive and augmented reality mobile experience. This capability may be enabled by leveraging the augmented reality, seat, infotainment ECU, drive unit controllers, etc. via a vehicle 12 CAN or ethernet connection whereby the augmented reality glasses, wands, and other wearable devices 30, 32 may be wirelessly connected to the augmented reality system 10 to provide two way communication between the occupant and the vehicle 12. This approach may provide the occupants 14, 16 with an augmented reality experience to be compensated for or accentuated by actual vehicle 12 dynamics. The connections may also allow the occupant to control the vehicle 12 (slow, stop, change navigation route, points of interest (POI), etc. without actual vehicle 12 physical controls, human-machine-interfaces (HMI), or other traditional occupant interaction methods

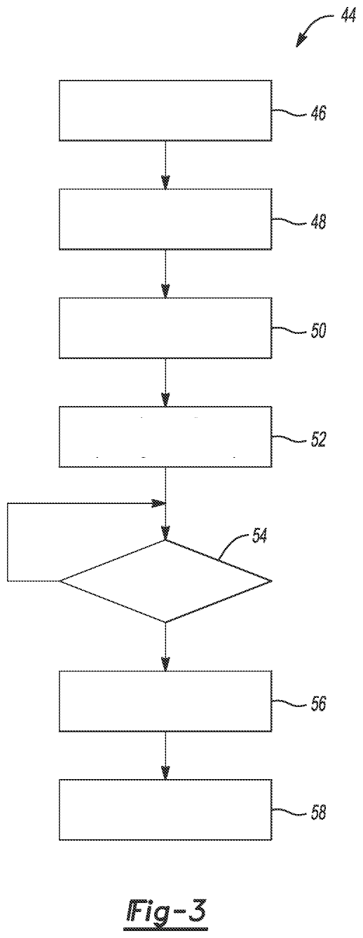

FIG. 3 illustrates a flowchart 44 of a method for providing an augmented reality experience in accordance with one non-limiting aspect of the present disclosure. The method is predominantly described with respect to providing an augmented reality experience for multiple passengers 14, 16 within an autonomous vehicle 12 for exemplary and non-limiting purposes as the present disclosure fully contemplates its use and application in other environments in with other devices in addition to autonomous vehicles 12. Block 46 relates to a registration process for detecting visual and gesture devices worn on or by passengers 14, 16 within the autonomous vehicle 12, such as according to wireless signaling exchanged between the device controller 24 and the passenger wearables 30, 32. The registration process 46 may include establishing an identity of the passenger 14, 16 associated with the wearable 30, 32, a subscription status, or other information pertinent to the passenger 14, 16, e.g., a passenger profile indicating the passengers 14, 16 preferences for information, personal traits, history, etc.

The registration process 46 may optionally include exchanges between the device controller 24, the augmented reality controller 26, and/or a back office (not shown) associated with the autonomous vehicle 12 or a purveyor of the augmented reality experience, e.g., the back office may be contacted to determine subscription, entitlements, capabilities, etc. purchased by the subscriber 14, 16 to facilitate the augmented reality experience. One non-limiting aspect of the present disclosure contemplates the passengers 14, 16 purchasing subscriptions to augmented reality experiences whereby the passengers 14, 16 may desire those purchases, etc. to be available for use with different autonomous vehicles 12, such as by enabling the passenger 14, 16 to transport a desired augmented reality experience from one autonomous vehicle 12 to another autonomous vehicle 12. The ability to keep track of passenger preferences and desires may be beneficial in enabling the passenger 14, 16 to have a personalized augmented reality experience across different transport mechanisms, e.g., passengers 14, 16 can port their augmented reality to different autonomous vehicles 12 so that autonomous vehicles 12 may have a similar and/or a consistent feel to the passenger 14, 16.

Block 48 relates to a theme selection process for selecting one or more augmented reality themes for each passenger within the autonomous vehicle 12. The augmented reality scene may correspond with a topic, playbill, representation, staging, theatrical performance, etc., that each passenger 14, 16 may individually desire to experience while traveling within the autonomous vehicle 12. The augmented reality themes may be divided according to various categories and preferences, optionally with each passenger 14, 16 selecting the desired theme from a drop-down menu or other available listing as a function of virtual interactions made through use of the visual and gesture devices 30, 32. One non-limiting aspect of the present disclosure contemplates the augmented reality themes including a spaceship theme whereby virtual objects 18 may be generated to present a space travel experience, a commuter bus theme whereby virtual objects 18 may be generated to present an interior of the bus, e.g., to virtually represent a pull cord or other mechanism for drawing a bus to a stop, a points of interest theme whereby virtual objects 18 may be changed as the vehicle 12 travels to present related points of interest to the passenger, a hot air balloon theme whereby virtual objects 18 may be generated to present a flying-type of experience whereby the passenger feels as if they are floating in a hot air balloon, etc.

Block 50 relates to a virtual object generation process for generating the virtual objects 18 associated with the selected one or more of the augmented reality themes. One non-limiting aspect of the present disclosure contemplates each passenger 14, 16 selecting multiple augmented reality themes, such as to select the commuter bus and the points of interest theme whereby virtual objects 18 may be determined for presenting an interior bus type of scene to the passenger while additionally presenting what may be of interest to the passenger 14, 16, such as to illustrate bus stops, restaurants, stores, events, etc. along a route to a destination. The virtual object generation process, as such, may correspond with selecting the virtual items, graphics, images, a censure to be presented to each passenger 14, 16 while traveling in autonomous vehicle 12, and optionally with each passenger 14, 16 selecting different virtual themes and doing so in coordination with timestamps, geolocation information, etc. so that timing information can be generated and/or used to facilitate presenting, removing, and otherwise altering the virtual objects 18 according to the desired theme, travel of autonomous vehicle 12, commands from the passenger, etc. The virtual object generation process may optionally include animating, varying, or otherwise manipulating the virtual objects and/or operation of the gesture device to reflect real word changes in the autonomous vehicle 12, such to facilitate engaging a tactile element of the gesture device according to a real speed of the autonomous vehicle such that a vibration induced thereby increases and decreases in proportion to the real speed increasing and decreasing and/or to animate one or more of the virtual objects according to a real speed of the autonomous vehicle such that an animation speed of the animated one or more is increases and decreases as the real speed increases and decreases.

Block 52 relates to an object overlay process for generating the object overlays to be displayed through the visual device 30. The object overlay process may be combined or included as part of the virtual overlay process 50, at least in so far as the present disclosure fully contemplating both processes being simultaneously performed, i.e., the generation of the virtual objects 18 may include contemporaries generating the computer code, graphics, images, operating requirements, etc. (e.g., object overlays) associated with facilitating the display thereof through the visual device 30. One non-limiting aspect of the present disclosure separates the two processes in order to demonstrate an exemplary process whereby the virtual objects 18 may be provided from the back office to the augmented reality controller 26 whereafter the augmented reality controller 26 may then process the provided information to generate the object overlays, such as according to instructions provided from the device controller 30. This bifurcation may be beneficial enabling the device controller 24 to adapt or otherwise instruct augmented reality controller 26 as to the generation of the object overlays, which may enable the object overlay to be useable with varying types of wearable 30, 32 and across different types of autonomous vehicles 12.

The present disclosure is predominantly described with respect to the augmented reality experience being facilitated through virtual objects 18 presented within the visual device 30 such that the virtual objects 18 may include some visual component, with a visual component, overlay, etc. being displayed within a real environment of the associated passenger 14, 16. This may be accomplished in illustrated manner whereby virtual objects 18 may be presented through the glasses or other heads-display of the passenger 14, 16 while the passengers 14, 16 simultaneously view the real environment, e.g., the passengers 14, 16 may use their peripheral vision or otherwise look past the virtual objects 18 to view the real environment 38. The present disclosure, however, fully contemplates its use and application with and particularly contemplates leveraging the use of non-visual virtual objects 18, either as standalone virtual objects 18 and/or as add-ons to the visual objects, such as to provide auditory messaging, touch, smell, etc., which may optionally necessitate the passenger wearing an additional, corresponding device.

Block 54 relates to a virtual interaction detection process whereby the device controller 30 and/or the augmented reality controller 32 may coordinate to determine virtual interactions between the passengers 14, 16 and one or more of the virtual objects 18. The virtual interactions may correspond with the passengers 14, 16 actuating the gesture device 32 relative to the virtual objects 18, such as by moving the pointer icon 40 to a desired one or more of the virtual objects 18 and making a corresponding interaction. The virtual interactions may be detected in this manner based on signaling transmitted from the gesture device 32 to the device controller 30, which the device controller 30 may then relate to the augmented reality controller 26 for further processing assessment of the related virtual interaction. The virtual interactions may be used in this manner and related to the displayed or other interface virtual objects 18 in order to assess conditions, parameters, etc. associated with the passengers 14, 16 interaction with the virtual object. The augmented reality controller 26 may keep track of the virtual interactions and changes to the virtual objects 18 in order to map or otherwise track corresponding activities, e.g., the same portion of the passengers 14, 16 displayed may display different virtual objects 18 at different times such that the selection thereof may have different meanings or intentions depending on virtual object 18 displayed at the time of selection.

Block 56 relates to a virtual command generation process whereby the augmented reality controller may process the virtual interactions for purposes of generating one or more virtual commands. The virtual commands may be considered as instructions, requirements, edicts, etc. generated by the augmented reality controller 26 to represent control desired by the passenger 14, 16 as a function of the interaction with one or more of the virtual objects 18. The virtual commands, as such, may correspond with actions requested by the passenger 14, 16 to be made with respect to a corresponding one or more of the virtual objects 18. The virtual commands may be virtual in the sense that they may be software driven or a set of instructions separate from and independent of corresponding real-world controls available for the autonomous vehicle 12. The virtual commands, for example, may relate to changing or scrolling through virtual objects 18, switching from one augmented reality theme to another, requests to stop the autonomous vehicle 12, slow at a point of interest, pull over at a bus, etc. The virtual commands, as such, may be a result derived from the passengers 14, 16 interaction with the virtual objects 18, which standing alone may be insufficient to implement actual control or real-world manipulation of the autonomous vehicle 12.

Block 58 relates to a real command generation process whereby the augmented reality controller 26 may process the virtual commands for purposes of generating one or more real commands. The real commands may be commands executable in the real world to facilitate real control of the autonomous vehicle 12, i.e., real commands sufficient for stopping, turning, speeding up, or otherwise controlling the autonomous vehicle 12 and/or controlling real system onboard the autonomous vehicle 12, such as to facilitate controlling HVAC, radio, seat, window, and other onboard systems. The real commands may be derived from the virtual interaction so as to provide the passengers 14, 16 with capabilities to control the autonomous vehicle 12 in a manner that the passengers 14, 16 would otherwise be unable to control due to the autonomous vehicle 12 lacking a steering wheel and other real-world physical actuators, e.g., the economist vehicle 12 may lack an accelerator, a brake, a steering wheel, a window control, etc. such that the passengers 14, 16 would otherwise be unable to implement real-world controls for stopping, turning, braking, etc. The real commands may be transmitted over a vehicle 12 network to a corresponding controller onboard autonomous vehicle 12 whereby the vehicle controller may verify authenticity of the command prior to implementation and/or check or otherwise verify the implementation thereof with the back office.

The capability of the present disclosure to personalize virtual objects 18 and use corresponding virtual interactions and commands to generate real commands is believed to be beneficial in enabling passengers 14, 16 to become more involved with their autonomous transportation, particularly with respect to enabling passengers 14, 16 to select their desired augmented reality theme and to otherwise personalize their experience to facilitate real-world control of the autonomous vehicle 12 in a manner believed to improve autonomous transport. The present disclosure, accordingly, contemplates implementing control of autonomous vehicle decisions, operations, and dynamics based on inputs from an occupant's augmented reality devices 30, 32, allowing occupants to connect augmented reality equipment to a wireless interface instead of requiring physical vehicle controls, which for example, may be used to reach out in augmented reality space to pull a city bus stop string to request the autonomous vehicle 12 to stop asap or at a point of interest, push the string to tell the autonomous vehicle 12 to slow down while passing the current location or an upcoming point of interest, enable autonomous vehicle occupants to customize their riding experiences through the use of augmented reality and provide inputs to their augmented reality experience by using actual vehicle sensor inputs, and/or to control the rider's experience through the communication of yaw, speed, acceleration sensors (consumed via CAN/Ethernet) to control changes in the autonomous vehicle rider's augmented reality.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions), unless otherwise indicated expressly or clearly in view of the context, including the appended claims, are to be understood as being modified in all instances by the term “about” whether or not “about” actually appears before the numerical value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An augmented reality system for passenger control of an autonomous vehicle, comprising:
an augmented reality controller operable to provide an augmented reality experience for a plurality of passengers while traveling within the autonomous vehicle, the augmented reality experience including:
associating one or more of an available plurality of augmented reality themes with each of the passengers;
selecting virtual objects for each of the passengers based on the augmented reality theme associated therewith;
providing object overlays to visual devices associated with each of the passengers, the object overlays visually displaying virtual objects within a real environment of the passenger associated therewith; and
recognizing virtual interactions of the passengers with the virtual objects based on signaling transmitted from a gesture device of the passenger associated therewith; and
an autonomous vehicle controller operable to control a real operation of the autonomous vehicle according to a virtual command generated by the augmented reality controller in response to the virtual interactions.

2. The augmented reality system according to claim 1, wherein:
the autonomous vehicle is autonomously controlled to transport the passengers to a destination;
the virtual objects represent points of interest along a route to the destination; and
the real operation is a stop operation or a slowdown operation associated with stopping or slowing the autonomous vehicle at one or more of the points of interest.

3. The augmented reality system according to claim 2, wherein the augmented reality controller selects different points of interest for the passengers depending on the augmented reality theme associated therewith.

4. The augmented reality system according to claim 1, wherein one of the virtual objects is a window control actuator and the real operation is an actuate window operation associated with raising or lowering a real window included as part of the autonomous vehicle.

5. The augmented reality system according to claim 1, wherein:
the augmented reality controller selects a bus theme for each of the passengers, the virtual objects associated therewith including object overlays for displaying a virtual bus cord to each of the passengers;
the augmented reality controller generates the virtual command as a virtual stop command when the virtual interactions of one of the passengers indicates the associated passenger to have actuated the virtual bus cord; and
the autonomous vehicle controller is operable to stop the vehicle in response to the virtual stop command.

6. The augmented reality system according to claim 1, wherein the autonomous vehicle is a driverless type of vehicle lacking a real actuator for the passengers to request the real operation independently of the augmented reality experience

7. A method for augmented reality passenger control of an autonomous vehicle, comprising:
providing object overlays to a visual device worn on a passenger, the object overlays visually depicting virtual objects within a real environment of the passenger;
detecting virtual interactions of the passenger with the virtual objects; and
controlling a real operation of the autonomous vehicle within the real environment based on the virtual interactions.

8. The method according to claim 7, wherein the real operation is a stop operation associated with autonomously navigating to and stopping the vehicle at a location of interest selected by the passenger with one of the virtual interactions, the virtual interactions being detected according to signaling communicated from a gesture device, and the gesture device being worn on or carried by the passenger separately from the visual device to register a non-verbal physical gesture made by the passenger.

9. The method according to claim 7, further comprising selecting one or more the virtual objects to represent points of interest along a route to a destination of the autonomous vehicle, and controlling the real operation to include stopping or slowing the autonomous vehicle at one or more of the points of interest in response to one or more of the virtual interactions.

10. The method according to claim 7, further comprising selecting one or more of the virtual objects to represent selectable controls for one or more real systems onboard the autonomous vehicle, and wherein the real operation includes controlling one or more of the real systems in response to one or more of the virtual interactions.

11. The method according to claim 7, further comprising selecting one or more of the virtual objects to represent selectable controls for a window control actuator, and wherein the real operation includes raising or lowering a real window included as part of the autonomous vehicle in response to one or more of the virtual interactions therewith.

12. An augmented reality system for passenger control of an autonomous vehicle, comprising
a device controller operable to detect and communicate with a visual device worn on or carried by a passenger within the autonomous vehicle;
an augmented reality controller operable with the device controller to provide an augmented reality experience for the passenger while traveling within the autonomous vehicle, the augmented reality experience including displaying virtual objects to the passenger via the visual device; and
an autonomous vehicle controller operable to control a real operation of the autonomous vehicle according to a virtual command generated by the augmented reality controller in response to virtual interactions of the passenger with the virtual objects.

13. The augmented reality system according to claim 12, wherein the augmented reality experience includes:
determining an augmented reality theme for the passenger;
selecting virtual objects for the passenger based on the augmented reality theme;
providing object overlays to the visual device via the device controller, the object overlays visually depicting the virtual objects within a real environment of the passenger; and
detecting the virtual interactions according to signaling transmitted to the device controller from a gesture device worn on or carried by the passenger.

14. The augmented reality system according to claim 13, wherein the augmented reality controller:
determines the augmented reality theme to be a selected one of a plurality of augmented reality themes made available to the passenger through a subscription; and
identifies the selected one of the plurality of augmented reality themes according to a corresponding one or more of the virtual interactions.

15. The augmented reality system according to claim 13, wherein the augmented reality controller is operable to vibrate or engage a tactile element of the gesture device according to a real speed of the autonomous vehicle such that a vibration induced thereby increases and decreases in proportion to the real speed increasing and decreasing.

16. The augmented reality system according to claim 12 wherein the autonomous vehicle lacks a brake pedal or other real actuator for the passengers to request the real operation independently of the augmented reality experience.

17. The augmented reality system according to claim 12 wherein the real operation is a navigation operation associated with autonomously navigating to another destination or temporarily to another route other than a predefined destination or a predefine route pre-programmed for the autonomous vehicle.

18. The augmented reality system according to claim 12 wherein the augmented reality controller is operable to animate one or more of the virtual objects according to a real speed of the autonomous vehicle such that an animation speed of the animated one or more is increases and decreases as the real speed increases and decreases.

19. The augmented reality system according to claim 12 wherein the augmented reality controller is operable to select and update points of interest displayed as one or more of the virtual objects as a function of changes in a location of the autonomous vehicle registered while the autonomous vehicle travels to a pre-programmed destination.

20. The augmented reality system according to claim 12 wherein the autonomous vehicle controller generates and transmits a real command over a vehicle network to command a real vehicle system to implement the real operation.
